(19) United States
(12) Patent Application Publication
(10) Pub. No.: US 2020/0309179 A1
(43) Pub. Date: Oct. 1, 2020

(54) EXPANSIBLE ANCHOR

(71) Applicant: fischerwerke GmbH & Co. KG, Waldachtal (DE)

(72) Inventors: Martin LINKA, Horb a.N. (DE); Tobias HIRSCHLE, Jettingen (DE); Raphael DIXA, Waldachtal (DE)

(21) Appl. No.: 16/308,867

(22) PCT Filed: Jun. 26, 2017
(86) PCT No.: PCT/EP2017/065615

§ 371 Date: Dec. 11, 2018

(30) Foreign Application Priority Data
Jun. 29, 2016 (DE) 10 2016 111 906.7

(51) Int. Cl. F16B 13/06

(52) U.S. Cl. CPC F16B 13/065

(57) ABSTRACT

An expansible anchor for anchoring in a drilled hole, having a shank. An expansion sleeve of the expansible anchor can be arranged to be expanded radially by drawing in an expander body. In order to hold the expansion sleeve in place axially during expansion in a drilled hole there is arranged on the shank a resilient ring which has an annular main body having a weakened position, so that to modify its diameter the resilient ring is deformable in the circumferential direction. At least one projection extending radially outwards from the main body is arranged on the resilient ring.

The invention relates to an expansible anchor having the features of the preamble of claim 1.

German Offenlegungsschrift DE 37 07 510 A1 discloses an expansible anchor made of metal which is anchorable in a drilled hole by expansion of an expansion sleeve. For expanding the expansion sleeve the expansible anchor has a conical nut as expander body which is drawn into the expansion sleeve by screwing in a screw and the expansion sleeve is thereby expanded. On the shank of that expansible anchor there is arranged a resilient ring as holding element which holds the expansion sleeve in an intended position in the drilled hole. Also arranged on the shank of the expansible anchor is a sleeve having longitudinal ribs as anti-corotation means for the expansion sleeve, which prevents the expansion sleeve from corotation during expansion in the drilled hole.

The problem of the invention is to propose an alternative fixing element that is easy to mount.

That problem is solved according to the invention by an expansible anchor having the features of claim 1 which is suitable for anchoring in a drilled hole in an anchoring substrate, especially for anchoring in an anchoring substrate made of a solid material, especially concrete. The expansible anchor according to the invention has a shank having an expander body, a neck portion and a load-application means which are arranged one after the other along a longitudinal axis. In addition, a spacer portion can be arranged on the shank, especially between the neck portion and the load-application means. The longitudinal axis is parallel to or identical with the direction of introduction of the expansible anchor into a drilled hole. The shank of the expansible anchor according to the invention is especially made from steel and especially made in one piece. The expansible anchor is especially formed as a bolt anchor, that is to say the shank is especially made from and in one piece, for example from a piece of steel wire by cold mass forming, as is customary in the case of bolt anchors. This allows the expansible anchor to be produced economically and to have a simple structure with a small number of parts. The load-application means is especially implemented in the form of an external thread onto which a nut can be screwed for securing a mounted component. Alternatively the load-application means can also be in the form of an internal thread or a kind of bayonet closure, a hook or an eyelet, this list not being exhaustive. The expander body serves for expanding the expansion sleeve. The expander body is especially arranged at the end of the expansible anchor that is at the front in the introduction direction and is especially configured in such a way that its diameter increases in the introduction direction, towards the front end of the expander body, at least in some regions. The expander body especially has a conical or frustoconical shape. Unless otherwise indicated, “diameter” here and hereinbelow is to be understood as being the external diameter. In the case of a cross-section other than a circular cross-section, “diameter” is to be understood as being the diameter of a circle circumscribing the cross-section. The “introduction direction” is the direction in which the expansible anchor is introduced into the drilled hole. “Front” and “rear” always relate to the introduction direction. The end of the expansible anchor that is at the front in the introduction direction is accordingly that end of the expansible anchor which is first to enter a drilled hole when the expansible anchor is inserted into a drilled hole as intended. The expander body is connected at its rear end to the neck portion. The neck portion is a portion on the shank of the expansible anchor which is especially arranged between the expander body and the load-application means and which has a smaller diameter than the expander body at its cross-section of largest diameter. A spacer portion can be arranged between the neck portion and the load-application means, which spacer portion has a larger diameter than the neck portion. The neck portion and spacer portion especially have the shape of cylinders which are connected to one another at their base and top surfaces, respectively. In an unexpanded state the expansion sleeve is arranged on the neck portion so as to be axially movable relative to the shank, the expansion sleeve encompassing the neck portion in the circumferential direction over more than half of its circumference. By drawing the expander body into the expansion sleeve, the expansion sleeve can be expanded radially, that is to say enlarged or widened in diameter in a radial plane relative to the longitudinal axis. As a result, in a drilled hole the expansion sleeve is moved towards the wall of the drilled hole by the expander body and clamped against the wall of the drilled hole by frictional and/or interlocking engagement. In particular, for expansion the expander body is moved along the longitudinal axis relative to and towards the expansion sleeve, especially in a direction opposite to the introduction direction. The expansible anchor is in the “unexpanded” state when the expansion sleeve has not yet been made wider, that is to say when the expander body has not yet been drawn into the expansion sleeve for expansion. In order to hold the expansible anchor in the drilled hole, a resilient ring is arranged on the shank of the fixing element. The resilient ring is especially made of plastics and has an annular main body having an opening in which the shank is accommodated. The main body encompasses the shank of the expansible anchor, especially the neck portion of the expansible anchor, over more than half of the circumference. The main body has a weakened position, so that to modify its diameter the resilient ring is deformable in the circumferential direction, especially resiliently, that is to say reversibly. “Weakened position” is to be understood herein as being especially a slot, a groove or a spring-like element which, by virtue of its shaping, facilitates a modification of the circumference of the resilient ring and thereby a modification of the external and/or internal diameter of the resilient ring. It is also possible for a plurality of weakened positions to be provided, for example alternately in the introduction direction and in a direction opposite to the introduction direction and spaced apart from one another in the circumferential direction. The weakened position especially completely severs the main body of the resilient ring at one location, especially in the form of a slot in an axial and radial direction, with the result that ends directed towards one another are formed on either side of the weakened position, which ends can be moved towards one another and away from one another, so that the diameter of the resilient ring is modified. In the undeformed state the ends can be spaced apart from one another. The diameter can especially be made smaller by radial pressure and made larger again by relaxation of the pressure. Accordingly, by virtue of its deformability in a radial and/or circumferential direction, the resilient ring can be adapted to the actual diameter of a drilled hole. By compression of the resilient ring, the resilient ring can in addition be pressed against the shank to such an extent that, by virtue of the frictional action, the resilient ring is held on the shank so as to be fixed against relative rotation. For mounting on the shank of the fixing element, a resilient ring so configured can simply be pushed on by a radial movement and is also resiliently deformable by radial pressure. In order that a good hold in the drilled hole is ensured, the diameter of the resilient ring in an undeformed state is larger than the diameter of the expansion sleeve in the unexpanded state. The “undeformed” state of the resilient ring is the state in which the resilient ring has not yet been compressed. Outside a drilled hole, the expansible anchor and the expansion sleeve are intended to be in the unexpanded state and the resilient ring in the undeformed state. After introduction into a drilled hole, but before the clamping of the expansible anchor, the resilient ring is in the deformed state, because it is designed to be compressed on introduction into the drilled hole and clamped against the wall of the drilled hole, while after the clamping of the expansible anchor, by which the expansion sleeve is expanded, the expansible anchor is in the expanded state and the resilient ring in the deformed state.

According to the invention the resilient ring has at least one radially outwardly extending projection. Such a radially extending projection is deformable, especially resiliently deformable, in a radial direction. In particular, the projection is a resiliently flexible cantilever arm which is especially produced integrally with the main body of the resilient ring, especially integrally with the main body from plastics.

By the combination of the weakened position with the projection on the main body, the resilient ring is readily compressible in a radial and/or circumferential direction. The resilient ring can therefore very easily be adapted to a wide variety of different drilled hole diameters by compression, with the result that in the undeformed state it has a relatively large external diameter, so that even in a wide drilled hole it can be clamped to a sufficient extent against the wall of the drilled hole, while it can be compressed to a small diameter for insertion into a narrow drilled hole. “Narrow” and “wide” drilled hole refers herein to the tolerance range of a drilled hole of nominal diameter, as defined especially in the “Guideline for European technical approval of metal anchors for use in concrete”, ETAG 001, Annex A, Edition 1997, 3rd Amended, April 2013 under point 3. For example, for an expansible anchor of nominal diameter 12 mm, a 12 mm hole is drilled using a drill having a cutter diameter of from 12.1 mm to 12.5 mm, the smaller cutter diameter producing a narrow drilled hole and the larger cutter diameter producing a wide drilled hole. Both in a narrow drilled hole and in a wide drilled hole, the resilient ring of the expansible anchor according to the invention finds sufficient purchase to act as a counter-bearing for the expansion sleeve, so that for expansion the expander body can be drawn into the expansion sleeve without the expansion sleeve being pulled out of the drilled hole by the expander body. In the case of expansible anchors, the nominal diameter of the expansible anchor usually corresponds to the diameter of the drilled hole into which the expansible anchor is designed to be introduced, rounded to whole millimetres.

Preferably the resilient ring has at least three radially extending projections which are especially distributed uniformly around the main body in the circumferential direction, so that the projections centre the resilient ring in a drilled hole.

The diameter of the resilient ring is especially larger than the diameter of the drilled hole, especially larger than the nominal diameter of the drilled hole, into which the expansible anchor is designed to be introduced, so that the wall of the drilled hole exerts radial pressure on the resilient ring on insertion of the expansible anchor into the drilled hole. The resilient ring is accordingly in contact with the wall of the drilled hole, especially in such a way that, by virtue of the friction arising between the resilient ring and the wall of the drilled hole, the resilient ring is held in the drilled hole so as to be axially fixed and fixed against relative rotation. The expansion sleeve, however, need not be in contact with the wall of the drilled hole. On the contrary, the diameter of the expansion sleeve is especially chosen so that in the unexpanded state it is smaller than the nominal diameter of the expansible anchor, that is to say, for example, 9.8 mm in the case of an expansible anchor of nominal diameter 10 mm that is designed to be introduced into a 10 mm drilled hole. An expansible anchor so configured can be inserted without difficulty, and especially without the expansible anchor being struck with a hammer on its end that is at the rear in the introduction direction, into a drilled hole created with the designated nominal diameter and can nevertheless be securely and reliably expanded.

In order that the resilient ring also finds good purchase in wide drilled holes, however, in a preferred embodiment of the expansible anchor according to the invention the diameter of the resilient ring in the undeformed state is larger than the maximum diameter of the expander body. If the load-application means comprises a threaded portion, the diameter of the resilient ring in the undeformed state can especially also be larger than the diameter of the threaded portion.

In order that even in the case of a narrow drilled hole the expansible anchor can also be introduced into the drilled hole without a large amount of force, especially manually, the diameter of the resilient ring in the undeformed state is preferably a maximum of 1.3 times larger than the maximum diameter of the expander body of the expansible anchor according to the invention. In particular, the diameter of the resilient ring is a maximum of 1.25 times larger, especially a maximum of 1.2 times larger, than the maximum diameter of the expander body.

Preferably the resilient ring has at least one receiving space into which the projection is movable on insertion of the expansible anchor into a drilled hole. In particular, the receiving space is arranged on a circumferential surface of the main body, so that the projection can be moved at least to some extent into the receiving space on insertion of the expansible anchor into a drilled hole and can accordingly be accommodated by the main body. As a result of the movement of the projection into the receiving space, the projection no longer projects so far radially beyond the main body, so that the projection does not impede the insertion of the expansible anchor into a narrow drilled hole. As a result of the possible movement into the receiving space, the projection can nevertheless be of solid construction, so that it can achieve a sufficiently high holding force in a wide drilled hole and does not bend over or snap off when the resilient ring acts as counter-bearing for the expansion sleeve. The receiving space is especially configured in such a way that the receiving space can accommodate a minimum of 30%, especially a minimum of 40%, especially a minimum of 50% of the volume of the projection. In particular, a plurality of receiving spaces are provided into which one or more projections can be moved. In particular, a receiving space is provided for each projection.

In a further preferred embodiment of the expansible anchor according to the invention, the expansion sleeve has at least two expansion shells which are separated from one another by slots in the circumferential direction. The expansion shells are integrally connected to one another by at least one connecting web, with the result that the expansion sleeve can be produced economically by stamping and can be attached captively to the expansible anchor in a simple way by bending around the neck portion of the expansible anchor. A slot runs in the axial direction especially from a front end of the expansion sleeve to the connecting web. Adjacent expansion shells can be connected to one another directly by a connecting web, especially by a connecting web running in a circumferential direction. Alternatively, the expansion shells can also be connected to one another indirectly, for example by a slotted or unslotted connecting sleeve, it being possible for the connecting web then to be an axially extending connection to the sleeve body. The connecting web is generally the region of smallest cross-section by which an expansion shell is connected to another expansion shell. If an expansion shell is directly or indirectly connected to another expansion shell by a plurality of webs, the connecting web is the web having the smallest cross-section.

In order to ensure that the expansible anchor according to the invention also functions in wide drilled holes it is necessary for the resilient ring to find sufficient purchase in the drilled hole, so that it is able to act as counter-bearing for the expansion sleeve. This is ensured by the configuration of the expansible anchor according to the invention. A further improvement can be achieved if the expansion sleeve also expands even in the case of a small force, so that the resilient ring acting as counter-bearing needs to be supported on the wall of the drilled hole only against that small force.

In order that the expansion sleeve can be expanded even in the case of a small force, in a preferred embodiment of the expansible anchor according to the invention the quotient of the cross-sectional area of the connecting web with respect to the maximum diameter of the expander body is a maximum of 0.22 mm, especially a maximum of 0.20 mm and especially a maximum of 0.18 mm. As a result of the small area, the resistance with which the connecting web opposes expansion is sufficiently small.

In addition or alternatively, the quotient of the cross-sectional area of the connecting web with respect to the axial length of the slot that is adjacent to the connecting web in the axial direction is preferably a maximum of 0.25 mm, especially a maximum of 0.18 mm and especially a maximum of 0.13 mm, so that the expansion sleeve can be expanded especially easily.

Furthermore, it is preferred that the axial length of a connecting web is shorter than the radial thickness of the connecting web. In addition or alternatively, the axial length of a connecting web is preferably shorter than 2.5 mm, especially shorter than 2.0 mm and especially shorter than 1.5 mm.

In particular, the connecting web is formed at the rear end of the expansion shell, especially at the rear end of the expansion sleeve, so that there is as large as possible a lever arm between the expanding force, exerted at the front end of the expansion sleeve by the expander body, and the connecting web, with the result that a bending moment that is large in comparison with the expanding force acts in the connecting web, thus promoting easy expansion, in the case of a small axial force, on the resilient ring acting as counter-bearing.

The expansible anchor according to the invention can be introduced into a drilled hole created with the designated nominal diameter without a large amount of force, especially without it being necessary for the expansible anchor to be driven into a drilled hole with a hammer, the expansible anchor especially being pushed or inserted into the drilled hole manually by a user. It is therefore unnecessary to provide the expansible anchor according to the invention with a hammer-in pin at the end of the shank that is at the rear in the introduction direction, as is customary for known bolt anchors. According to the invention, a load-application means in the form of an external thread can accordingly extend as far as the end of the fixing element that is at the rear in the introduction direction, because there is no risk of the external thread being damaged by hammer blows during introduction of the expansible anchor into the drilled hole.

The invention is explained in greater detail below with reference to an exemplary embodiment shown in the Figures, wherein:

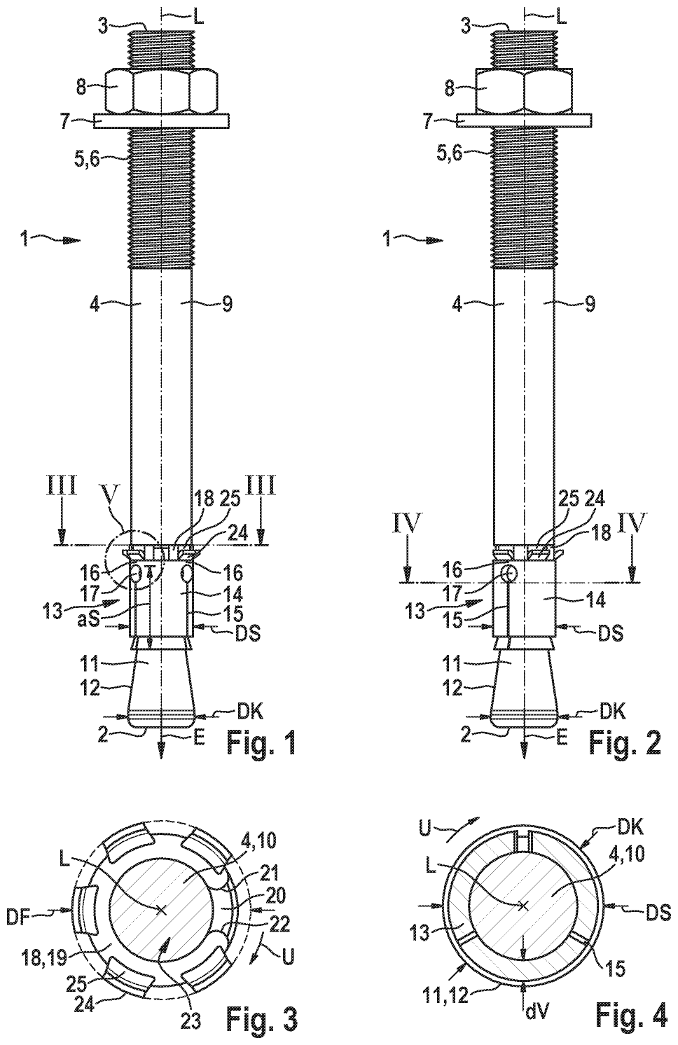

FIG. 1 is a side view of an expansible anchor according to the invention;

FIG. 2 is a further side view of the expansible anchor according to the invention;

FIG. 3 shows an axial section through the expansible anchor according to the invention in the plane III-III;

FIG. 4 shows an axial section through the expansible anchor according to the invention in the plane IV-IV; and

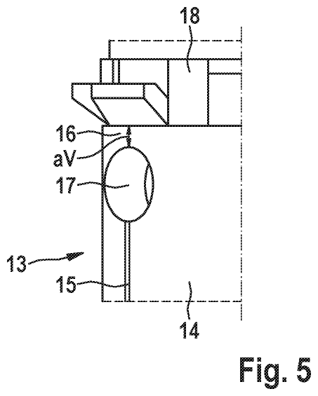

FIG. 5 shows detail V of FIG. 1.

The Figures show an expansible anchor 1 according to the invention as a fixing element for anchoring in a drilled hole (not shown) in an unexpanded state outside a drilled hole. The expansible anchor 1 extends along a longitudinal axis L from an end 2, which is at the front in the introduction direction E, to a rear end 3. The expansible anchor 1 is implemented as what is known as a bolt anchor having an elongated, peg-like shank 4 formed in one piece from steel. Starting from the rear end 3, an external thread 5 is provided on the shank 4 as load-application means 6, which external thread extends as far as the rear end 3 of the expansible anchor 1 and on which a washer 7 is arranged and onto which a nut 8 has been screwed. The external thread 5 is adjoined in the introduction direction E by a cylindrical spacer portion 9. In front of the spacer portion 9 in the introduction direction E there is arranged a neck portion 10 which is likewise cylindrical, but has a diameter which is smaller than the diameter of the external thread 5. The neck portion 10 is adjoined in the introduction direction E by an expander body 11, forming the front portion of the shank 4, which has a conical expander portion 12 which widens in diameter in the introduction direction E up to a maximum diameter DK of the expander body 11.

On the neck portion 10 there is arranged an expansion sleeve 13 consisting of three expansion shells 14 which are separated from one another in the circumferential direction U by slots 15 but are integrally connected to one another by connecting webs 16. The expansion sleeve 13 is expansible radially by drawing the expander body 11 into the expansion sleeve 13 between the expansion shells 14, with the result that the diameter DS of the expansion sleeve 13 is enlarged relative to the unexpanded state shown in the Figures. The expansion shells 14 are curved in the circumferential direction U and together form in cross-section a circular ring interrupted by the slots 15, as can be seen in FIG. 4. The slots 15 are widened at their rear ends by circular widened portions 17 which facilitate expansion of the expansion sleeve 13. The connecting webs 16 close the slots 15 at their rear ends and are arranged at the rear end of the expansion sleeve 13.

Between the expansion sleeve 13 and the transition from the neck portion 10 to the spacer portion 9, which transition is in the form of an annular step, there is arranged a resilient ring 18 for holding the expansible anchor 1 in a drilled hole. The resilient ring 18 has an annular, slotted main body 19 which is severed in a circumferential direction U at one location by a weakened portion 20, formed as a slot, so that on the main body 19 there are two ends 21, 22 which are directed towards one another and are movable relative to one another, with the result that to modify its diameter DF the resilient ring 18 is deformable in the circumferential direction U. As a result of the weakened position 20, the main body 19 forms an open circular ring having an opening 23 for receiving the neck portion 10 of the shank 4, as can be seen in FIG. 3.

Projections 24 are arranged on the main body 19 of the resilient ring 18 distributed in the circumferential direction U, which projections have been produced integrally with the resilient ring 18 from plastics, extend radially from the main body 19 and in the undeformed state define the diameter DF of the resilient ring 18. In the undeformed state shown in the Figures, the diameter DF of the resilient ring 18 is larger than the diameter DS of the expansion sleeve 13 in the unexpanded state shown in the Figures. In addition, in the undeformed state the diameter DF of the resilient ring 18 is 1.16 times larger than the maximum diameter DK of the expander body 11. In the circumferential surface of the main body 19 there are arranged rectangular recesses as receiving spaces 25 for the projections 24, there being a receiving space 25 for each projection 24. The projections 24 are arranged in the form of cantilever arms at the front ends of the receiving spaces 25 and extend radially from the main body 19 obliquely towards the rear. Their free ends can be resiliently bent in the axial direction, with the result that the diameter DF of the resilient ring 18 is modified and is able to adapt to the diameter of a drilled hole. On insertion of the expansible anchor 1 into a drilled hole, the projections 24 can, by bending, be moved into the receiving spaces 25 and can to at least some extent be accommodated by the receiving spaces 25. Each of the receiving spaces 25 therefore has a volume substantially corresponding to the volume of the associated projection 24.

The expansion shells 14 are connected to one another by connecting webs 16. In order that the expansion sleeve 13 can be expanded easily, that is to say in order that as small as possible an axial load can be used to push the expander body 11 between the expansion shells 14 axially, that is to say along the longitudinal axis L and in a direction opposite to the introduction direction E, with the result that the expansion shells 14 are moved radially outwards, the connecting webs 16 have a small cross-sectional area and accordingly a small moment of inertia. The cross-sectional area of a connecting web 16 is calculated from the axial length aV of the connecting web 16 and the radial thickness dV of the connecting web 16. The quotient of the cross-sectional area of the connecting web 16 with respect to the maximum diameter DK of the expander body 11 is 0.16 mm. The quotient of the cross-sectional area of the connecting web 16 with respect to the axial length aS of the slot 15 adjacent to the connecting web 16 in the axial direction is 0.13 mm. In absolute numbers, in the case of the expansible anchor 1 illustrated herein the axial length aV of the connecting web 16 is 1.0 mm, while the radial thickness dV of the connecting web 16 is 1.25 mm.

The expansion sleeve 13 has in the unexpanded state a diameter DS that is smaller than the nominal diameter of the expansible anchor 1. The nominal diameter of the expansible anchor 1 is the same as the nominal diameter of the drill to be used to drill the hole into which the expansible anchor 1 is to be introduced. In the case of the expansible anchor 1 according to the invention shown in the Figures the nominal diameter is 8 mm, whereas the diameter DS of the expansion sleeve 13 is 7.5 mm. The resilient ring 18, however, in the undeformed state has a diameter DF which, at 9.1 mm, is larger than the nominal diameter of the expansible anchor 1. When the expansible anchor 1 is inserted as intended into a drilled hole of a nominal diameter, the expansion sleeve 13 does not impede insertion, so that the expansible anchor 1 can be pushed or inserted into the drilled hole without a large amount of force, especially without using a hammer. During insertion, the radially outwardly extending projections 24 fold at least to some extent resiliently into the receiving spaces 25 of the resilient ring 18. The projections 24 rest with their radially outer, free ends in contact with the wall of the drilled hole and are pressed resiliently against the wall of the drilled hole. This gives rise to a frictional force between the resilient ring 18 and the wall of the drilled hole by means of which the resilient ring 18 is held axially fixed in the drilled hole, so that during expansion of the expansion sleeve 13 it is able to act as counter-bearing for the expansion sleeve 13. Once the expansible anchor 1 has been inserted, the shank 4 is moved out of the drilled hole in a direction opposite to the introduction direction E by tightening the nut 8. The expansion sleeve 13 is held axially by the resilient ring 18 as soon as the expander portion 12 of the expander body 11 is drawn between the expansion shells 14 of the expansion sleeve 13 and the expansion sleeve 13 thereby radially expanded. By virtue of the small cross-section of the connecting webs 16, only a small axial force is sufficient for the expansion shells 14 to be pressed apart radially by the expander body 11. That axial expansion force is smaller than the holding force of the resilient ring 18 acting as counter-bearing, which holding force likewise acts in the axial direction. As soon as the expansion shells 14 are pressed against the wall of the drilled hole by the expansion, the necessary expansion force can increase, because the expansion sleeve 13 is then itself clamped in the drilled hole so as to be axially fixed.

By virtue of its configuration according to the invention, the expansible anchor 1 shown in the Figures can easily, that is say using very little axial force, be introduced into a drilled hole and expanded, which renders handling by a user much simpler in comparison with the known bolt anchors. The expansible anchor 1 consists of a small number of parts, which are easy to assemble and therefore economical to produce.

### LIST OF REFERENCE SIGNS

### Expansible Anchor

1 expansible anchor
2 front end of the expansible anchor 1
3 rear end of the expansible anchor 1
4 shank
5 external thread
6 load-application means
7 washer
8 nut
9 spacer portion
10 neck portion
11 expander body
12 expander portion
13 expansion sleeve
14 expansion shell
15 slot
16 connecting web
17 widened portion of the slot 15
18 resilient ring
19 main body of the resilient ring 18
20 weakened position
21 first end of the main body 19
22 second end of the main body 19
23 opening of the main body 19
24 projection
25 receiving space of the resilient ring 18 for a projection 24
aS axial length of the slot 15
aV axial length of the connecting web 16
dV radial thickness of the connecting web 16
DF diameter of the resilient ring 18
DK diameter of the expander body 11
DS diameter of the expansion sleeve 13
E introduction direction
L longitudinal axis
U circumferential direction

1. An expansible anchor for anchoring in a drilled hole, having a shank which has an expander body, a neck portion and a load-application means which are arranged one after the other along a longitudinal axis, wherein in an unexpanded state there is arranged on the neck portion an expansion sleeve which is expansible radially by drawing the expander body into the expansion sleeve, wherein on the shank there is arranged a resilient ring for holding the expansible anchor in a drilled hole, which resilient ring has an annular main body having a weakened position, so that to modify its diameter the resilient ring is deformable in a circumferential direction, and wherein the main body has an opening in which the shank is accommodated, and wherein the diameter of the resilient ring in the undeformed state is larger than the diameter of the expansion sleeve in the unexpanded state,
wherein
the resilient ring has at least one projection extending radially outwards from the main body.

2. The expansible anchor according to claim 1, wherein at least three radially extending projections are arranged on the main body.

3. The expansible anchor according to claim 1, wherein the diameter of the resilient ring in the undeformed state is larger than the maximum diameter of the expander body.

4. The expansible anchor according to claim 1, wherein the diameter of the resilient ring in the undeformed state is a maximum of 1.3 times larger than the maximum diameter of the expander body.

5. The expansible anchor according to claim 1, wherein the resilient ring has at least one receiving space into which the projection is movable on insertion of the expansible anchor into a drilled hole.

6. The expansible anchor according to claim 1, wherein the expansion sleeve has at least two expansion shells which are separated from one another by slots in the circumferential direction but are integrally connected to one another by at least one connecting web.

7. The expansible anchor according to claim 6, wherein the quotient of the cross-sectional area of the connecting web with respect to the maximum diameter of the expander body is a maximum of 0.22 mm.

8. The expansible anchor according to claim 6, wherein the quotient of the cross-sectional area of a connecting web with respect to the axial length of the slot that is adjacent to the connecting web in the axial direction is a maximum of 0.25 mm.

9. The expansible anchor according to claim 6, wherein the axial length of a connecting web is shorter than the radial thickness of the connecting web.

10. The expansible anchor according to claim 6, wherein the axial length of the connecting web is shorter than 2.5 mm.

11. The expansible anchor according to claim 1, wherein the load-application means is an external thread which extends as far as the rear end of the expansible anchor.
